(19) United States
(12) Patent Application Publication
(10) Pub. No.: US 2004/0251694 A1
(43) Pub. Date: Dec. 16, 2004

(54) Gate latch mechanism

(76) Inventor: Dennis Gorski, Mission Viejo, CA (US)

Correspondence Address: Bruce B. Brunda, STETINA BRUNDA GARRED & BRUCKER, Suite 250, 75 Enterprise, Aliso Viejo, CA, 92656, US

(21) Appl. No.: 10/461,714

(22) Filed: Jun. 13, 2003

(51) Int. Cl. E05C 1/10

(52) U.S. Cl. 292/175

(57) ABSTRACT

A spring biased latch mechanism is provided for securing a door to a stationary post. The mechanism includes a latch body secured to a first side of the door, the latch body having first and second striker bar receiving flanges extending from the door, each of the flanges having at least one striker bar receiving aperture formed therein. The latch body further includes a compression spring flange extending from the door proximate the first striker bar receiving flange. A striker plate is connected to a stationary post. The striker plate includes a first flange extending from the post and having a striker bar receiving aperture formed therein. A striker bar supported by the latch body is translatable within the striker bar receiving apertures, and into the striker plate aperture. A compression spring is disposed between the latch body compression spring flange and the striker bar, the compressions spring being operative to urge the striker bar into locking engagement with the striker plate flange aperture.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

The present invention relates to latch mechanisms, and in particular latch mechanisms suitable for exterior wooden gates or the like.

Gate mechanisms are widely used for residential commercial purposes throughout the world. In residential uses, gate mechanisms are commonly applied to wooden gates which close against a stationary gate post. The temporary gate latch mechanisms having a bar that moves with the gate, receivable by a stationary catch mounted on the gate post. The catch is open by lifting a catch receiving member, e.g. by pulling a string, to open the gate. Alternate gate latch mechanisms include deadbolt locks, mounted on the surface of the gate and engageable to account a catch mounted on the gate post.

While such contemporary mechanisms are effective to close or lock a gate, they may suffer from a variety of common drawbacks. Preferably, a gate match mechanism should be formed of durable material, and spring loaded for positive closure. The gate mechanism will preferably also readily reversible to accommodate gates that open from the left or right side, without distorting the vertical arrangement of the mechanism.

These and other objects and advantages are addressed by the gate latch mechanism disclosed herein.

### BRIEF SUMMARY OF THE INVENTION

A spring biased latch mechanism is provided for securing a door to a stationary post. The mechanism includes a latch body secured to a first side of the door, the latch body having first and second striker bar receiving flanges extending from the door, each of the flanges having at least one striker bar receiving aperture formed therein. The latch body further includes a compression spring flange extending from the door proximate the first striker bar receiving flange. A striker plate is connected to a stationary post. The striker plate includes a first flange extending from the post and having a striker bar receiving aperture formed therein. A striker bar supported by the latch body is translatable within the striker bar receiving apertures, and into the striker plate aperture. A compression spring is disposed between the latch body compression spring flange and the striker bar, the compressions spring being operative to urge the striker bar into locking engagement with the striker plate flange aperture.

The mechanism may also include a first rod engaged to the striker bar and translatable therewith, the rod extending normal to the striker bar to facilitate manual operation of the latch mechanism from the first side of the door.

The mechanism may further include a cover plate connectable to the second side of the door, having a elongated aperture formed therein. First rod, or a separate second separate rod, may extend through the latch body elongated aperture, the door and the cover plate elongated aperture to facilitate manual opening of the latch mechanism from the second side of the door. As such, the striker bar may be translatable in response to movement of the rod from either of the first or second side of the doors.

The mechanism may also include a locking plate connected to and translatable with the striker bar. The locking plate includes the locking plate flange translatable through at least one locking plate receiving aperture formed in the first striker bar receiving flange. The locking plate flange may include an aperture for receiving a locking member which blocks translation of the locking plate within the locking plate receiving aperture, thereby disabling translation of the striker bar and maintaining the mechanism in a locked arrangement.

In one embodiment the striker plate receiving apertures are formed at opposing, vertically spaced positions on the first striker bar receiving flange, to facilitate reverse assembly of the mechanism for use on either right handed or left handed doors.

### BRIEF DESCRIPTION OF THE DRAWINGS

These as well as other features of the present invention will become more apparent upon reference to the drawings wherein:

FIG. 1 is a top view of a gate latch mechanism in accordance with the present invention;

FIG. 2 is a front view of the gate latch mechanism;

FIG. 3 is a front end view of the latch body;

FIG. 4a is a top view of the gate latch mechanism striker bar;

FIG. 4b is a rear view of the striker bar;

FIG. 4c is a front view of the striker bar;

FIG. 5 is a top view of a latch body and strike plate;

FIG. 6 is a front view of the latch body and strike plate;

FIG. 7 is a front view of the cover plate.

FIG. 8a is a top view of the locking plate;

FIG. 8b is a front view of the locking plate;

FIG. 8c is a side view of the locking plate;

FIG. 9a is a first elevation view of the latch body;

FIG. 9b is a second elevation view of the latch body;

FIG. 9c is a third elevation view of the latch body; and

FIG. 9d is a fourth elevation view of the latch body.

### DETAILED DESCRIPTION OF THE INVENTION

The description below, taken in combination with the accompanying illustrations, sets forth the presently preferred embodiment of the invention. The description of the construction, function and operation of the presently preferred embodiment is intended to be exemplary of the invention, and is not intended to preclude additional embodiments of the invention, as will be apparent to those of ordinary skill in the field. Additionally, the embodiment described below is set forth in connection with a wooden gate and fencepost. However, it is anticipated that the latch mechanism may have application in relation to other types of doors or openings beyond wooden gates. Accordingly, the description is not intended to preclude other constructions or applications that are within the broader aspects of the invention, as provided herein.

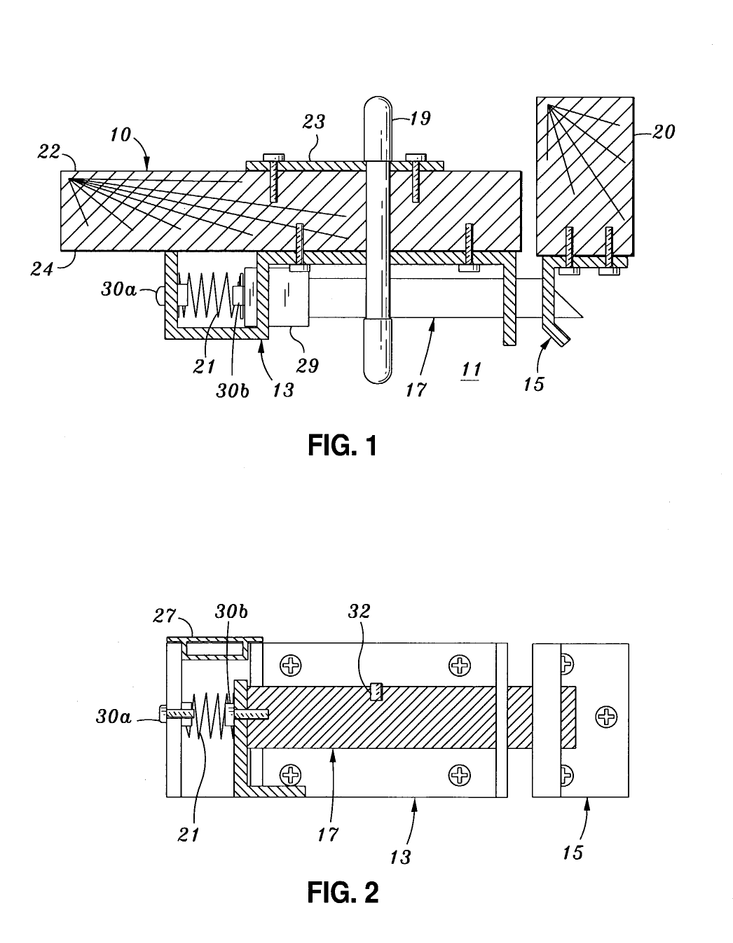

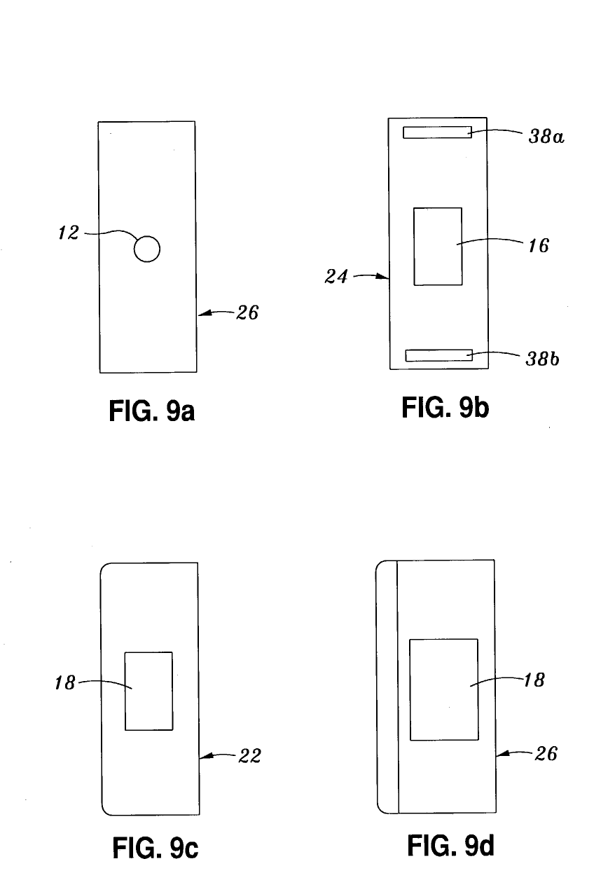

FIG. 1 is a top view of a latch mechanism constructed in accordance with the invention. The mechanism is shown mounted onto first and second sides, 22, 24 of a wooden gate door 10, which locks to stationary wooden gate post 20. The latch mechanism 11 includes a latch body 13 and strike plate 15. Striker bar 17 is supported by the latch body 13 and translates to engaging contact with strike plate 15. Rod 19 engages the striker bar 17, to facilitate translation of the striker bar 17. Compression spring 21 is secured against the latch body 13 and striker bar 17, to positively urge the striker bar 17 towards and into engagement with striker plate 15. Apertures formed in latch body 13 (see FIGS. 6, 9a-d) and cover plate 23 (see FIGS. 1, 2) allow striker bar 17, locking plate 32 and rod 19 to translate between locked and unlocked positions, with respect to the latch body.

The latch mechanism may be secured to wooden gate 10 and wooden post 20 by screws 30. A plastic cap 29 may also be provided to striker bar 17 to mitigate frictional engagement between striker bar 17 and latch body 13, during translation of the striker bar.

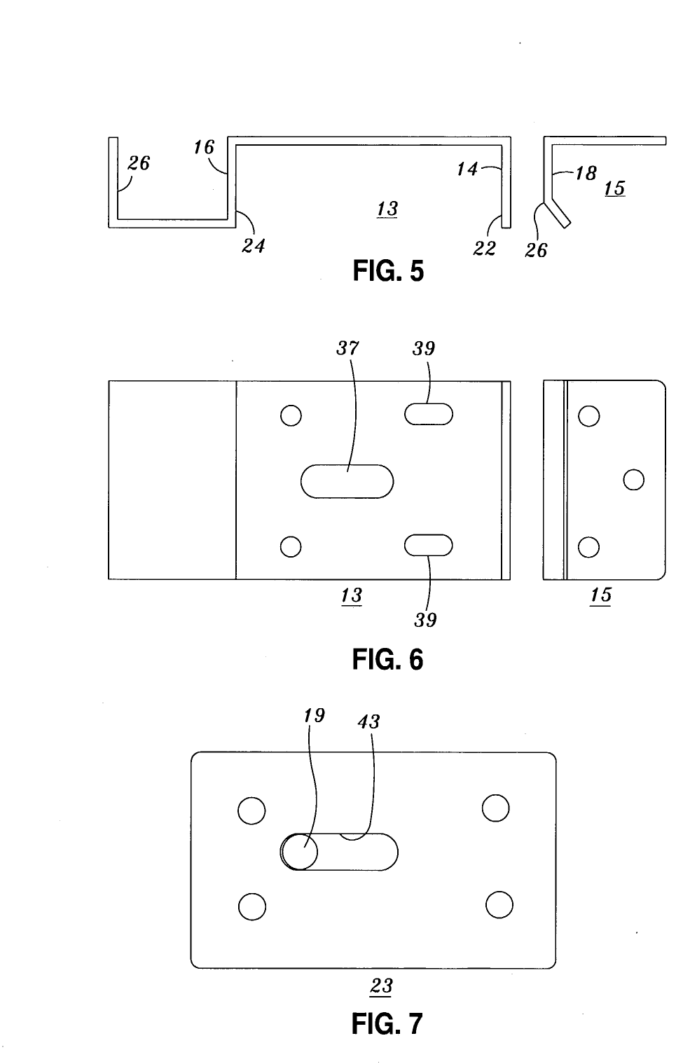

FIG. 2 is a front view of a latch mechanism in accordance with the present invention. As shown therein, the striker bar 17 translates through apertures 14, 16 in the latch body 13 (See FIG. 5) and aperture 18 in strike plate 15. Cap 27 may be provided to keep debris away from spring 21 and translating portions of the striker bar 17. Set screw 32 is useful to secure rod 19 with respect to translating striker bar 17.

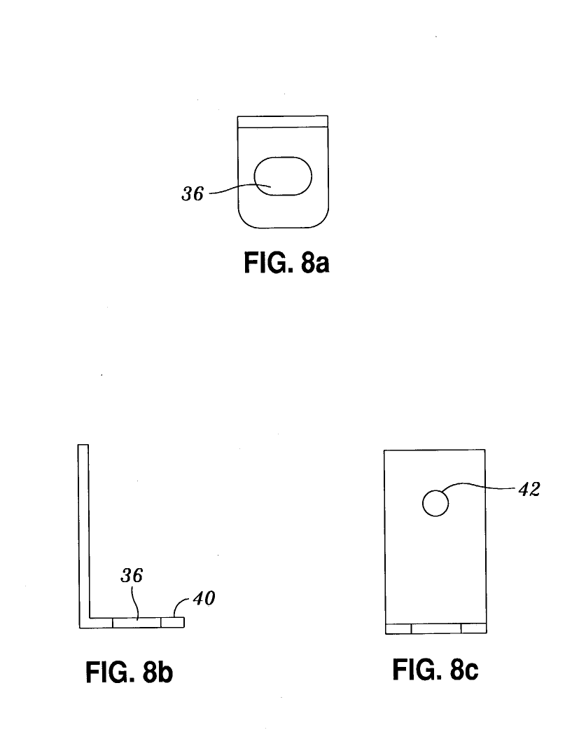

Locking plate 34 (shown in more detail at FIGS. 8a-c), translates with the striker bar 17. The locking plate 34 includes a horizontal flange 40 that can translate through aperture 38a, 38b (shown at FIG. 9b) depending upon the vertical orientation of the latch mechanism. As further explained below, the vertical orientation may be varied depending upon whether the latch mechanism is used for a right handed opening door or a left handed opening door. In either case, the horizontal flange 40 extends through the aperture 38a or 38b to guide the translating mechanism as the striker bar reciprocate the opening or closing.

Horizontal flange 40 includes an aperture 36 which enables locking of the gate mechanism. When a padlock, or some other locking member, is placed through aperture 36, of horizontal flange 40, the striker bar is unable to translate with respect to the latch body 13. Therefore the latch mechanism remains locked. If the padlock or locking member is removed, the horizontal flange 40 and striker bar 17 will again be able to translate with respect to latch body 13 and therefore the latch mechanism will be enabled for opening and closing movement.

Locking plate 34 also includes an aperture 42, adapted to receive set screw 30b (shown at FIGS. 1, 2) which secures the locking plate to the striker bar. Screw 30b also secures the compression spring against the locking plate 34, to provide positive locking of the striker bar 17.

If the latch mechanism is to be reversed, set screw 30b is removed, enabling disassembly of the locking plate 34 from the striker bar 17. The assembly may then be vertically reversed in order to be used on a door opening from the opposite side. The locking plate 34 may then be reconnected to the striker bar, albeit extending through the opposing aperture 38a, 38b, with cap 27 placed on the then top side of the assembly to protect the compression spring 21 and attached elements from moisture and debris. Importantly, disassembly of the locking plate 34 typically requires removal of the cap 27 and secure engagement of the nylon spacer 34 before set screw 30 can be removed to access and remove set screw 30b. The locking plate 34 may then be disconnected from strider bar 17 to enable disassembly, when the assembly is secured by a padlock extending through aperture 36 of locking plate 34 disassembly is at least difficult, and may be practically impossible.

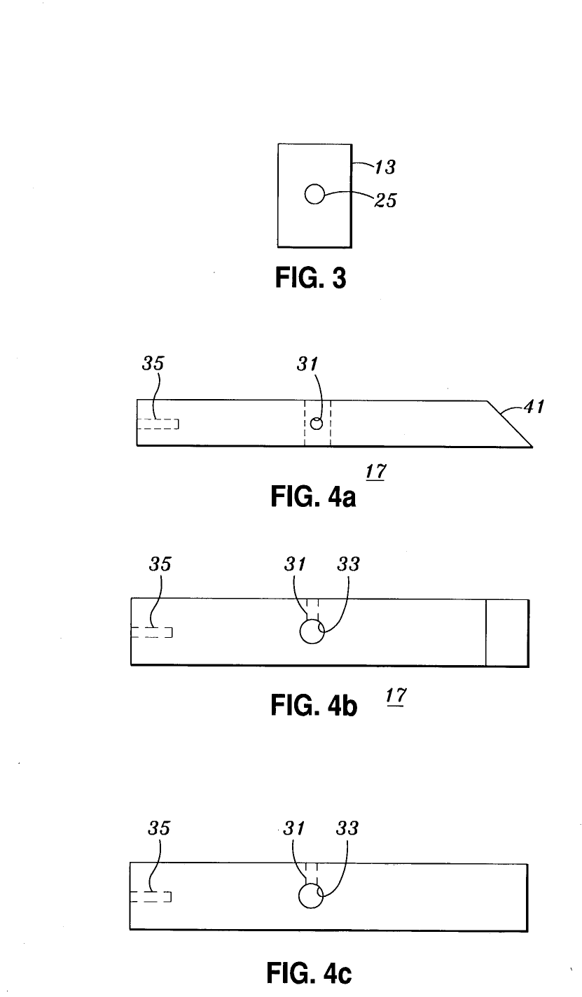

FIG. 3 is an end view of the latch body 13, illustrating aperture 25 which may receive a screw 30a (See FIG. 2) which engages rotating spacer 34 to secure spring 21 in place. FIGS. 4a, b, c provide top, rear and front views of the striker bar 17, respectively. As shown in FIG. 4a the striker bar 17 has a beveled first edge 41, which is extendable through aperture 18 in strike plate 15. Aperture 31 is formed to receive set screw 32 (shown in FIG. 2), to engage the rod 19 to striker bar 17. Aperture 35 is formed to receive a screw 30b, engaging spring 21 to the striker bar 17, as shown at FIG. 2. As shown at FIGS. 4b and 4c, striker bar 17 is provided with a central aperture 33, through which rod 19 is extendable.

FIGS. 5 and 6 illustrate the latch body 13 and strike plate 15, separate from the translating components and supporting structures. As shown at FIG. 5, latch body 13 is formed to have a generally S shaped profile, defined by striker bar receiving flanges 22, 24 and compression spring flange 26, also shown at FIG. 9a-d. Striker bar receiving flanges, 22, 24 are formed to include striker bar receiving apertures 14, 16, respectively, to facilitate translatable extension of the striker bar therethrough. Compression spring flange 26 is disposed generally proximate striker bar receiving flange 24, the separation therebetween substantially defining the maximum operating length of spring 21. Spacing between flanges 24, 26 may be selected in view of the spacing between latch body flange 22 and striker plate flange 26, as well as the desired travel of the striker bar through the strike plate aperture 18.

As shown at FIG. 6, the latch body and strike plate are formed to have a plurallity of apertures to facilitate mounting the latch body and strike plate onto the support members. Latch body 13 incorporates an elongated rod receiving/translating aperture 37, formed to receive rod 19, for translation as the gate latch mechanism is opened and closed. As shown at FIG. 6, other gate mounting apertures such as aperture 39, may also be formed in an elongated shape, for convenience of adjustment during installation.

FIG. 7 illustrates the construction of cover plate 23 disposed on the outside of the gate door, where an outside opening mechanism is desired. As shown therein cover plate 23 includes elongated cover plate aperture 43, formed to receive and facilitate the travel of rod 19, as the latch mechanism is opened and closed. As will be apparent to those of ordinary skill in the art, cover plate aperture 43 and latch body aperture 37 (FIG. 6) are formed to be substantially coextensive, aligned with an aperture that may be formed in the intermediate wooden gate door 10.

FIGS. 8a-8c illustrate different views of the locking plate 34 that is engaged to and travels with striker bar 17. The locking plate includes a locking plate aperture 42 that receives set screw 30b (FIG. 1, 2), to secure the locking plate 34 to the striker bar 17, to facilitate travel with the striker bar. The locking plate 34 further includes a lock receiving aperture 36, which can receive a pad lock or the like and may abut against or also extend through the latch body 13, thereby securing the locking plate to the latch body and precluding travel of the striker bar to prevent unlocking of the gate.

FIGS. 9a-9d provides elevational views of different sections of the latch body 13, as illustrated at FIG. 5. FIG. 9a illustrates an aperture 12 for receiving a screw 30a that supports one end of the spring 26. FIG. 9b illustrates aperture 16 for allowing travel of the striker bar 17, as well as apertures 38a, b, which facilitates travel of the locking plate 34 through the latch body 13. As noted from FIG. 9b, apertures 38a, b are provided in upper and lower portions of the latch body, to facilitate reversal of the orientation of the locking mechanism, to accommodate reversal of the latch mechanism from left-handed to right-handed doors. FIGS. 9c and 9d further illustrate apertures 14, 18 for facilitating the travel of the striker bar 17 through the latch body 13.

What is claimed is:

1. A spring based latch mechanism for securing a door to a stationary post comprising:
a) a latch body secured to a first side of the door, said latch body having
i) first and second striker bar receiving flanges extending from the door, each of the striker bar receiving flanges having at least one striker bar receiving aperture formed therein; and
ii) a compression spring flange extending from the door proximate the first striker bar receiving flange.
b) a striker plate connectable to the stationary post, the striker plate having a first flange extending from the post, said striker plate first flange having a striker bar receiving aperture formed therein;
c) a striker bar supported by the latch body and translatable within the striker bar receiving apertures, and into the striker plate aperture; and
d) a compression spring disposed between latch body compression spring flange and the striker bar, the compression spring being operative to urge the striker bar, into locking engagement with the striker plate flange aperture.
e) a first rod engaged to the striker bar and translatable therewith, the first rod extending normal to the striker bar to facilitate manual opening of the latch mechanism from the first side of the door.
f) a cover plate connectable to a second side of the door, the cover plate having an elongated aperture formed therein; and
g) the first rod extending through the latch body elongated aperture the door and the cover plate elongated aperture to facilitate manual opening of the latch mechanism from the second side of the door.

2. The mechanism as recited in claim 1 further comprising:

3. The mechanism as recited in claim 2 further comprising:

4. The latch mechanism as recited in claim 3 wherein the striker bar is translatable in response to movement of the rod from the first and second sides of the door.

5. The latch mechanism as recited in claim 1 wherein the latch body defines a substantially S vertical shaped profile.

6. The latch mechanism as recited in claim 1 wherein the striker bar is normally urged by the compression spring into engagement with the striker plate aperture.

7. The latch mechanism as recited in claim 1 wherein the striker bar is manually translatable towards the compression spring to allow displacement of the door from the stationary post.

8. The latch mechanism as recited in claim 1 wherein the striker bar has a beveled first end to facilitate entry of the striker bar into engagement with the striker plate aperture.

9. The latch mechanism as recited in claim 1 wherein the compression spring flange and the first striker receiving flange are spaced by a length less than the translation of the striker bar within the striker bar receiving apertures.

10. The latch mechanism as recited in claim 1 further comprising a locking plate engaged to the striker bar and translatable therewith, the locking plate including a locking plate flange extending substantially parallel to the striker bar a spaced distance therefrom; and wherein the first striker bar receiving flange includes at least one locking plate receiving aperture for receiving the locking plate flange, the locking plate flange being translatable within the locking plate receiving aperture.

11. The latch mechanism as recited in claim 10 wherein the locking plate flange includes a lock receiving aperture for receiving a locking member therethrough, the locking plate being precluded from translation within the locking plate receiving aperture when the locking member is extending through the lock receiving aperture.

12. The mechanisms as set forth in claim 11 wherein the first striker bar receiving flange is provided with a plurality of vertically spaced locking plate receiving flanges, the locking plate receiving flanges being spaced to receive the locking plate flange extending downwardly or upwardly from the striker bar, to facilitate reversible use of the mechanism for right handed and left handed doors.
